(19) United States
(12) Patent Application Publication
(10) Pub. No.: US 2026/0189280 A1
(43) Pub. Date: Jul. 2, 2026

(54) AI-BASED CSI REPORTING METHOD AND APPARATUS, AI-BASED CSI RECEIVING METHOD AND APPARATUS, AND STORAGE MEDIUM

(71) Applicant: Beijing Xiaomi Mobile Software Co., Ltd., Beijing (CN)

(72) Inventor: Qin MU, Beijing (CN)

(73) Assignee: Beijing Xiaomi Mobile Software Co., Ltd., Beijing (CN)

(21) Appl. No.: 18/857,551

(22) PCT Filed: Apr. 18, 2022
(86) PCT No.: PCT/CN2022/087501

§ 371 Date: Oct. 17, 2024

(51) Int. Cl. H04B 7/06

(52) U.S. Cl. CPC H04B 7/0626; H04B 7/0617; H04B 7/0632

(57) ABSTRACT

An AI-based CSI reporting method includes: a terminal reporting, on the basis of a codebook, a first CSI corresponding to a downlink pilot signal to a network device; receiving a beamforming downlink pilot signal sent by the network device, the beam of the beamforming downlink pilot signal being determined by the network device by means of AI on the basis of the first CSI; reporting, on the basis of the codebook, a second CSI corresponding to the beamforming downlink pilot signal to the network device, the second CSI being used by the network device for downlink data transmission.

### CROSS-REFERENCE TO RELATED APPLICATIONS

The present application is a U.S. National Stage of International Application No. PCT/CN2022/087501, filed on Apr. 18, 2022, the disclosure of which is incorporated herein by reference in its entirety for all purposes.

### TECHNICAL FIELD

The present disclosure relates to the field of communications, and in particular to a reporting method, receiving method and device for channel status information (CSI) based on artificial intelligence (AI), and a storage medium.

### BACKGROUND

At present, in the third Generation Partnership Project (3GPP), Type I codebook and Type II codebook are used to implement quantized feedback of CSI.

Comparing the CSI feedback of Type I codebook and the CSI feedback of Type II codebook, the CSI feedback based on Type I codebook has low overhead, low precoding accuracy, low degree of matching with the channel, and low data transmission performance, while the CSI feedback based on Type II codebook has higher overhead, higher precoding accuracy, higher degree of matching with the channel, and better data transmission performance.

### SUMMARY

The embodiments of the present disclosure provide an AI-based CSI reporting method, receiving method, and device, and a storage medium.

According to an aspect of the embodiments of the present disclosure, there is provided an AI-based CSI reporting method, the method being performed by a terminal, and the method including:
reporting first CSI corresponding to a downlink pilot signal to a network device based on a codebook;
receiving a beamformed downlink pilot signal sent by the network device, where a beam of the beamformed downlink pilot signal is determined by the network device through AI based on the first CSI; and
reporting second CSI corresponding to the beamformed downlink pilot signal to the network device based on the codebook, where the second CSI is used for the network device to perform downlink data transmission.

According to another aspect of the embodiments of the present disclosure, there is provided an AI-based CSI receiving method, the method being performed by a network device, and the method including:
receiving first CSI, where the first CSI is CSI corresponding to a downlink pilot signal that is reported by a terminal based on a codebook;
determining, through AI based on the first CSI, P beams for a beamformed downlink pilot signal, where P is a positive integer;
sending the beamformed downlink pilot signal to the terminal based on the P beams; and
receiving second CSI, where the second CSI is CSI corresponding to the beamformed downlink pilot signal that is reported by the terminal based on the codebook, and the second CSI is used for the network device to perform downlink data transmission.

According to another aspect of the embodiments of the present disclosure, there is provided an AI-based CSI reporting device, the device including:
a sending module, configured to report first CSI corresponding to a downlink pilot signal to a network device based on a codebook;
a receiving module, configured to receive a beamformed downlink pilot signal sent by the network device, where a beam of the beamformed downlink pilot signal is determined by the network device through AI based on the first CSI;
the sending module is configured to report second CSI corresponding to the beamformed downlink pilot signal to the network device based on the codebook, where the second CSI is used for the network device to perform downlink data transmission.

According to another aspect of the embodiments of the present disclosure, there is provided an AI-based CSI receiving device, the device including:
a receiving module, configured to receive first CSI, where the first CSI is CSI corresponding to a downlink pilot signal that is reported by a terminal based on a codebook;
a processing module, configured to determine P beams for a beam-formed downlink pilot signal through the AI based on the first CSI, where P is a positive integer;
a sending module, configured to send the beamformed downlink pilot signal to the terminal based on the P beams;
the receiving module is configured to receive second CSI, where the second CSI is CSI corresponding to the beamformed downlink pilot signal that is reported by the terminal based on the codebook, and the second CSI is used for the network device to perform downlink data transmission.

According to another aspect of the embodiments of the present disclosure, there is provided a terminal, the terminal including:
a processor; and
a transceiver connected to the processor;
where the processor is configured to execute executable instructions to implement the AI-based CSI reporting method as described in the above aspects.

According to another aspect of the embodiments of the present disclosure, there is provided a network device, the network device including:
a processor; and
a transceiver connected to the processor;
where the processor is configured to execute executable instructions to implement the AI-based CSI receiving method as described in the above aspects.

According to another aspect of the embodiments of the present disclosure, there is provided a computer storage medium is provided, where the computer-readable storage medium stores at least one piece of instructions, at least one program segment, a code set, or an instruction set, and the at least one piece of instruction, the at least one program segment, the code set, or the instruction set is loaded and executed by a processor to implement the AI-based CSI reporting method as described in the above aspects, or the AI-based CSI receiving method b as described in the above aspects.

According to another aspect of the embodiments of the present disclosure, there is provided a computer program product (or computer program), where the computer program product (or computer program) includes computer instructions that are stored in a computer-readable storage medium; a processor of a computer device reads the computer instructions from the computer-readable storage medium, and the processor executes the computer instructions to cause the computer device to perform the AI-based CSI reporting method as described in the above aspects, or the AI-based CSI receiving method as described in the above aspects.

According to another aspect of the embodiments of the present disclosure, there is provided a chip, including a programmable logic circuit and/or program instructions, and the chip, when being running, is configured to implement the AI-based CSI reporting method as described in the above aspects, or the AI-based CSI receiving method as described in the above aspects.

It is to be understood that the foregoing general description and the following detailed description are illustrative and explanatory only and are not restrictive of the present disclosure.

### BRIEF DESCRIPTION OF THE DRAWINGS

In order to more clearly illustrate the technical solutions in the embodiments of the present disclosure, the drawings required for use in the description of the embodiments will be briefly introduced below. Obviously, the drawings described below are only some embodiments of the present disclosure. For those of ordinary skill in the art, other drawings can be obtained based on these drawings without paying any creative effort.

FIG. 1 is a schematic diagram of a communication system according to an illustrative embodiment;

FIG. 2 is a flow chart of a CSI reporting method based on AI according to an illustrative embodiment;

FIG. 3 is a flow chart of a CSI reporting method based on AI according to another illustrative embodiment;

FIG. 4 is a flow chart of a CSI receiving method based on AI according to an illustrative embodiment;

FIG. 5 is a flow chart of a CSI receiving method based on AI according to another illustrative embodiment;

FIG. 6 is a flowchart of a CSI reporting method based on AI according to another illustrative embodiment;

FIG. 7 is a flowchart of a CSI reporting method based on AI according to another illustrative embodiment;

FIG. 8 is a flowchart of a CSI reporting method based on AI according to another illustrative embodiment;

FIG. 9 is a flowchart of a CSI reporting method based on AI according to another illustrative embodiment;

FIG. 10 is a flow chart of a CSI reporting method based on AI according to another illustrative embodiment;

FIG. 11 is a block diagram of a CSI reporting device based on AI according to an illustrative embodiment;

FIG. 12 a block diagram of is a CSI receiving device based on AI according to an illustrative embodiment;

FIG. 13 is a structural schematic diagram of a terminal according to an illustrative embodiment; and

FIG. 14 is a structural schematic diagram of a network device according to an illustrative embodiment.

### DETAILED DESCRIPTION

Illustrative embodiments will be described in detail herein, examples of which are shown in the accompanying drawings. When the following description refers to the drawings, the same numbers in different drawings represent the same or similar elements unless otherwise indicated. The embodiments described in the following illustrative embodiments do not represent all embodiments consistent with the present disclosure. Instead, they are merely examples of devices and methods consistent with some aspects of the present disclosure as detailed in the appended claims.

At present, 3GPP uses Type I codebook and Type II codebook for CSI quantized feedback. Comparing the CSI feedback of Type I codebook and the CSI feedback of Type II codebook, the CSI feedback based on Type I codebook has low overhead, low precoding accuracy, low degree of matching with the channel, and low data transmission performance, while the CSI feedback based on Type II codebook has higher overhead, higher precoding accuracy, higher degree of matching with the channel, and better data transmission performance.

Therefore, how to further reduce the CSI feedback overhead while keeping the precoding accuracy unchanged, or how to obtain higher precoding accuracy while keeping the CSI feedback overhead unchanged, in order to obtain better data transmission performance, is an urgent problem to be solved.

AI technology has been widely used in various industries due to its powerful computing and reasoning capabilities and its ability to fit arbitrary nonlinear functions. In a large-scale Multiple Input Multiple Output (MIMO) system, a terminal (transmitting end) uses the sparsity of the channel to convert the space-frequency channel into the angle-delay domain through a two-dimensional Discrete Fourier Transform (DFT), the channel information can be regarded as picture information, and then the terminal (receiving end) compresses the channel information using an autoencoder to obtain compressed information, and feeds the compressed information to a network device. The network device (i.e., the receiving end) restores the compressed information to the original channel information through a decoder. When using AI for CSI feedback in the above technical solution, it is necessary to deploy the autoencoder and the decoder at the transmitting end and the receiving end respectively, and the autoencoder and decoder need to be jointly trained to support the implementation of the above technical solution, which is completely different from the conventional CSI reporting method, and thus a lot of 3GPP standardization work is required.

In order to solve the above technical problems, the present disclosure provides an AI-based CSI reporting method and an AI-based CSI receiving method, as shown in the following embodiments.

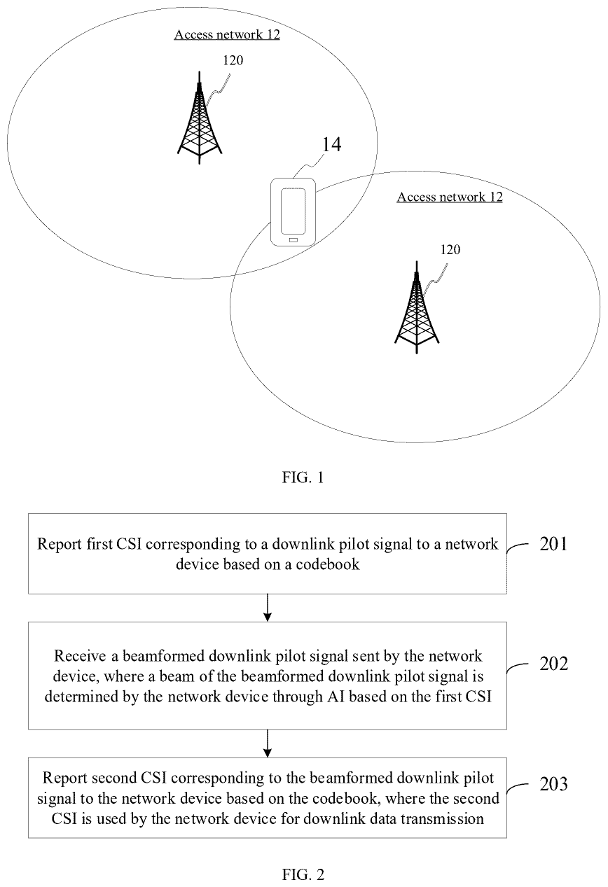

FIG. 1 is a block diagram of a communication system provided by an illustrative embodiment of the present disclosure. The communication system may include an access network 12 and a user terminal (User Equipment, UE) 14.

The access network 12 includes several network devices 120. The network device (also called access network device) 120 can be a base station, which is a device deployed in the access network to provide wireless communication functions for user terminals (“terminals” for short) 14. The base stations can include various forms of macro base stations, micro base stations, relay stations, access points, etc. In systems using different wireless access technologies, the name of device with base station functions may be different, for example, in the Long Term Evolution (LTE) system, it is called eNodeB or eNB; in the 5G NR (New Radio) system, it is called gNodeB or gNB. With the evolution of communication technology, the description of “base station” may change. For the convenience of description in the embodiments of the present disclosure, the devices that provide wireless communication functions for the user terminal 14 are collectively referred to as network devices.

The user terminal 14 may include various handheld devices with wireless communication functions, vehicle-mounted devices, wearable devices, computing devices or other processing devices connected to a wireless modem, as well as various forms of user devices, mobile stations (MSs), terminal devices, etc. For the convenience of description, the above devices are collectively referred to as user terminals. The network device 120 and the user terminal 14 communicate with each other through a certain air interface technology, such as a Uu interface.

For example, there are two communication scenarios between the network device 120 and the user terminal 14, an uplink communication scenario and a downlink communication scenario. The uplink communication refers to sending signals to the network device 120, and the downlink communication refers to sending signals to the user terminal 14.

For example, an AI model is deployed in the network device 120, and the AI model is used to perform prediction of precoding based on CSI feedback.

The technical solutions of the embodiments of the present disclosure can be applied to various communication systems, such as a Global System of Mobile Communication (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD) system, Advanced Long Term Evolution (LTE-A) system, New Radio (NR) system, evolution system of the NR system, LTE-based access to Unlicensed spectrum (LTE-U) system, NR-U system, Universal Mobile Telecommunication System (UMTS), Worldwide Interoperability for Microwave Access (WiMAX) communication system, Wireless Local Area Networks (WLAN), Wireless Fidelity (WiFi), next generation communication system or other communication systems, etc.

Generally, the number of connections supported by traditional communication systems is limited and easy to implement. However, with the development of communication technology, mobile communication systems will not only support traditional communications, but also support, for example, Device to Device (D2D) communication, Machine to Machine (M2M) communication, Machine Type Communication (MTC), Vehicle to Vehicle (V2V) communication, Vehicle to Everything (V2X) system, etc. The embodiments of the present disclosure can also be applied to these communication systems.

FIG. 2 is a flow chart of a CSI reporting method based on AI provided by an illustrative embodiment of the present disclosure. The method is applied to the communication system shown in FIG. 1 and is performed by a UE. The method includes the following.

Step 201, first CSI corresponding to a downlink pilot signal is reported to a network device based on a codebook.

The terminal receives a downlink pilot signal sent by the network device; generates first CSI based on the downlink pilot signal; and reports the first CSI to the network device based on a codebook. For example, the downlink pilot signal is periodically sent by the network device, or is aperiodically sent by the network device. In some examples, the downlink pilot signal includes a Channel Status Information-Reference Signal (CSI-RS).

For example, the terminal determines second downlink channel information based on the downlink pilot signal; determines the first CSI based on the second downlink channel information; and reports the first CSI to the network device based on the codebook.

In some examples, the first CSI includes Precoding Matrix Indication (PMI); or the first CSI includes PMI and Rank Indication (RI); or the first CSI includes PMI, RI, and first Channel Quality Indication (CQI). The first CQI is determined based on the downlink pilot signal. For example, the first CQI is determined based on the second downlink channel information corresponding to the downlink pilot signal.

In some examples, in the case where the first CSI includes PMI, the terminal reports PMI corresponding to the downlink pilot signal to the network device based on the codebook. For example, the terminal determines the second downlink channel information based on the downlink pilot signal; determines PMI based on the second downlink channel information; and reports PMI to the network device based on the codebook.

In some examples, in the case where the first CSI includes PMI and RI, the terminal reports PMI and RI corresponding to the downlink pilot signal to the network device based on the codebook. For example, the terminal determines the second downlink channel information based on the downlink pilot signal; determines RI and PMI corresponding to RI based on the second downlink channel information; and reports PMI and RI to the network device based on the codebook.

In some examples, in the case where the first CSI includes PMI, RI and first CQI, the terminal reports the PMI, RI and first CQI corresponding to the downlink pilot signal to the network device based on the codebook. For example, the terminal determines the second downlink channel information based on the downlink pilot signal; determines the PMI, RI and first CQI based on the second downlink channel information; and reports the PMI, RI and first CQI to the network device based on the codebook.

For example, the second downlink channel information is information of a channel that is used for sending the downlink pilot signal. For example, if the channel is denoted as H, the second downlink channel information can be denoted as H, where His a channel matrix.

For example, the terminal may determine the PMI corresponding to the maximum allowed number of transport streams of the terminal based on the second downlink channel information. Alternatively, the terminal may determine the PMI corresponding to the number of transport streams indicated by the RI based on the second downlink channel information.

Alternatively, before receiving the downlink pilot signal, the terminal receives a codebook parameter configured by the network device; the terminal may determine the PMI corresponding to the maximum allowed number of transport streams based on the codebook parameter and the second downlink channel information. The RI may be used to indicate the number of transport streams reported by the terminal to the network device. The number of transport streams indicated by the RI is less than or equal to the maximum allowed number of transport streams of the terminal.

For example, the maximum allowed number of transport streams of the terminal is rank=4, and the second downlink channel information is H; the terminal can determine the PMI corresponding to rank=4 based on H. For another example, the rank indicated by the RI of the terminal is 2, and the second downlink channel information is H; the terminal can determine the PMI corresponding to rank=2 based on H.

For example, the terminal stores the maximum allowed number of transport streams predefined by a protocol, and the terminal determines the maximum number of transport streams as a value of RI. Alternatively, the terminal may determine the value of RI based on the second downlink channel information. Alternatively, before receiving the downlink pilot signal, the terminal receives a codebook parameter configured by the network device, and the terminal may determine the value of RI based on the codebook parameter and the second downlink channel information.

For example, in the case where the terminal receives the codebook parameters, no matter whether the terminal stores the maximum allowed number of transport streams predefined by the protocol or not, the terminal determines the value of RI based on the codebook parameters and the second downlink channel information.

For example, the maximum allowed rank of the terminal is 6, and the terminal may determine the maximum allowed rank=6 as the value of RI. For another example, the terminal may determine the value of RI to be 2 based on H. For another example, the terminal may determine the value of RI to be 4 based on H and a Type II codebook parameter.

In some examples, the codebook includes a codebook of Type I or a codebook of Type II. The codebook parameter include a Type I codebook parameter or a Type II codebook parameter. For example, the codebook parameters are configured for the terminal by the network device through Radio Resource Control (RRC).

For example, the maximum allowed number of transport streams of the terminal may be predefined by the protocol. For example, the maximum allowed number of transport streams of the terminal is defined in the communication protocol. Alternatively, the maximum allowed number of transport streams of the terminal may be determined based on a codebook parameter configured by the network device. For example, the terminal determines the maximum allowed number of transport streams based on a Type II codebook parameter configured by the network device. For example, the downlink pilot signal is used to measure a downlink channel.

Step 202, a beamformed downlink pilot signal sent by the network device is received, where a beam of the beamformed downlink pilot signal is determined by the network device through AI based on the first CSI.

The terminal receives the beamformed downlink pilot signal sent by the network device through P beams, where P is a positive integer. In some examples, the beamformed downlink pilot signal includes a beamformed CSI-RS.

In some examples, the number of the beams P is any one of the following:
the maximum allowed number of transport streams of the terminal; or
the number of transport streams indicated by the RI reported by the terminal.

Step 203, second CSI corresponding to the beamformed downlink pilot signal is reported to the network device based on the codebook, where the second CSI is used by the network device for downlink data transmission.

The terminal generates the second CSI based on the beamformed downlink pilot signal; and reports the second CSI to the network device based on the codebook.

For example, the terminal determines first downlink channel information based on the beamformed downlink pilot signal; determines the second CSI based on the first downlink channel information; and reports the second CSI to the network device based on the codebook. The first downlink channel information is downlink effective channel information determined based on the beamformed downlink pilot signal. It should be noted that the downlink effective channel information can also be called downlink equivalent channel information.

In some examples, in the case where the first CSI includes only PMI, the second CSI includes CQI, and the terminal reports the CQI corresponding to the beamformed downlink pilot signal to the network device based on the codebook. For example, the terminal determines the first downlink channel information based on the beamformed downlink pilot signal; determines the CQI based on the first downlink channel information; and reports the CQI to the network device based on the codebook.

In some examples, in the case where the first CSI includes PMI and RI, the second CSI includes CQI, and the terminal reports the CQI corresponding to the beamformed downlink pilot signal to the network device based on the codebook. For example, the terminal determines the first downlink channel information based on the beamformed downlink pilot signal; determines the CQI based on the first downlink channel information; and reports the CQI to the network device based on the codebook.

In some examples, in the case where the first CSI includes only PMI, the second CSI includes RI and CQI, and the terminal reports RI and CQI corresponding to the beamformed downlink pilot signal to the network device based on the codebook. For example, the terminal determines the first downlink channel information based on the beamformed downlink pilot signal; determines RI and CQI based on the first downlink channel information; and reports RI and CQI to the network device based on the codebook.

In some examples, in the case where the first CSI includes PMI, RI and first CQI, the second CSI includes second CQI, and the terminal reports the second CQI corresponding to the beamformed downlink pilot signal to the network device based on the codebook. The second CQI is determined based on the beamformed downlink pilot signal. For example, the second CQI is determined based on the first downlink channel information corresponding to the beamformed downlink pilot signal; that is, the terminal determines the first downlink channel information based on the beamformed downlink pilot signal; determines the second CQI based on the first downlink channel information; and reports the second CQI to the network device based on the codebook. The second CQI is used to update the first CQI in the network device so that the downlink data transmission is performed based on the second CQI.

For example, the terminal may determine the PMI based on the maximum allowed number of transport streams of the terminal in the process of feeding back the first CSI; and determine the RI corresponding to the currently used channel based on the first downlink channel information in the process of feeding back the second CSI.

For example, the codebook used by the terminal when reporting the second CSI is the same as or different from the codebook used when reporting the first CSI. For example, the terminal uses a Type I codebook or a Type II codebook when reporting the first CSI and the second CSI. For another example, the terminal uses the Type I codebook to report the first CSI and uses the Type II codebook to report the second CSI; or the terminal uses the Type II codebook to report the first CSI and uses the Type I codebook to report the second CSI.

For example, the first downlink channel information is information of a channel used for sending the beamformed downlink pilot signal. For example, the channel is denoted as H, and the precoding matrix is denoted as W, then the first downlink channel information can be denoted as H*W, where the precoding matrix is determined by the network device through the AI based on the first CSI.

In summary, according to the AI-based CSI reporting method provided in this embodiment, a codebook is used on the terminal side for CSI feedback, and AI is used on the network device side. The network device determines the beams required for transmission of the beamformed downlink pilot signal based on AI, that is, the AI network is deployed only on the network device side, and the terminal side does not need to deploy the AI network, and can still use the codebook to perform the CSI feedback, and thus there is no need for too much standardization work. Compared with traditional CSI reporting, this technical solution can improve downlink data transmission performance under the same CSI feedback overhead because the network device side can restore the precoding with higher-precision based on AI.

In some other embodiments, before receiving the downlink pilot signal and the beamformed downlink pilot signal sent by the network device, the terminal receives downlink pilot signal resources configured by the network device, and then receives the downlink pilot signal and the beamformed downlink pilot signal based on the downlink signal resources.

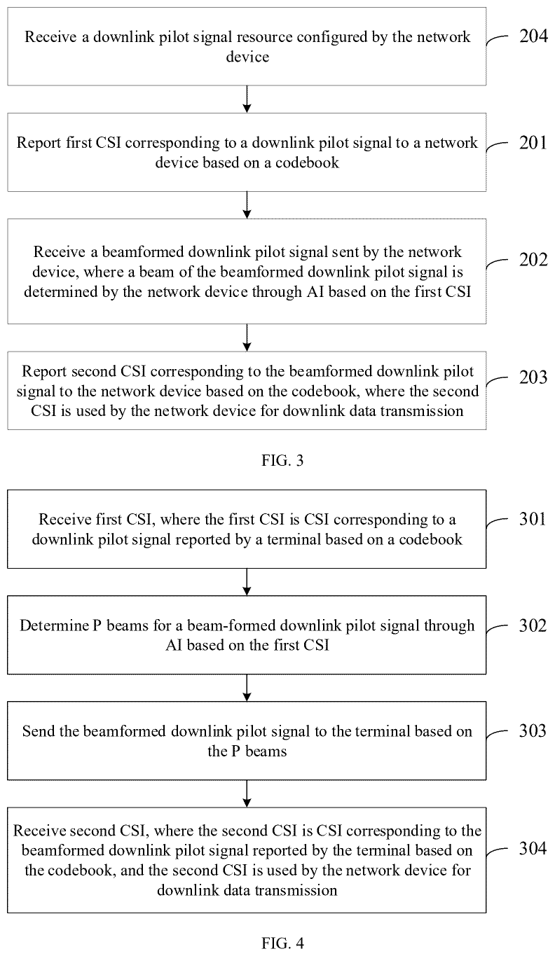

For example, as shown in FIG. 3, the CSI reporting method based on AI may further include step 204 before step 201, as shown below.

Step 204, a downlink pilot signal resources configured by the network device is received.

For example, in the CSI feedback process, the terminal receives the downlink pilot signal sent by the network device through K ports of the downlink pilot signal resource; and then receives the beamformed downlink pilot signal sent by the network device through the K ports of the downlink pilot signal resource, where K is a positive integer and K is less than or equal to P.

In some examples, the terminal receives at least two downlink pilot signal resources configured by the network device.

For example, the at least two downlink pilot signal resources include a first downlink pilot signal resource corresponding to the beamformed downlink pilot signal and a second downlink pilot signal resource corresponding to the downlink pilot signal.

In some examples, the at least two downlink pilot signal resources have the same or different numbers of ports. For example, the number of ports of the first downlink pilot signal resource and the number of ports of the second downlink pilot signal resource are both K1, and K1 is a positive integer. For another example, the number of ports of the first downlink pilot signal resource is K1, and the number of ports of the second downlink pilot signal resource is K2, and K1 and K2 are positive integers with different values.

For example, in the case where the numbers of ports of the at least two downlink pilot signal resources are the same, during the CSI feedback process, the terminal receives the downlink pilot signal sent by the network device through the K ports of the second downlink pilot signal resource; and also receives the beamformed downlink pilot signal sent by the network device through the K ports of the first downlink pilot signal resource based on P beams.

In some examples, the number K of ports of the downlink pilot signal resource is configured by the network device for the terminal; or the number K of ports of the downlink pilot signal resource is determined according to the maximum allowed number of transport streams of the terminal; or the number K of ports of the downlink pilot signal resource is determined according to the number of transport streams indicated by the RI reported by the terminal.

For example, the number of ports of the first downlink pilot signal resource corresponding to the beamformed downlink pilot signal is any one of the following:
a value indicated by RI;
a value predefined by a protocol; or
a value that is configured for the terminal by the network device.

In some examples, the downlink pilot signal includes at least one of a CSI-RS or a DeModulation Reference Signal (DMRS); the beamformed downlink pilot signal includes at least one of a beamformed CSI-RS or a beamformed DMRS. For example, the downlink pilot signal is a CSI-RS, and the beamformed downlink pilot signal is a beamformed CSI-RS. For another example, the downlink pilot signal is a DMRS, and the beamformed downlink pilot signal is a beamformed DMRS.

In some examples, in the case where the downlink pilot signal is the CSI-RS and the beamformed downlink pilot signal is the beamformed CSI-RS, at least two CSI-RS resources belong to the same or different CSI-RS resource sets. For example, the first CSI-RS resource and the second CSI-RS resource both belong to the same CSI-RS resource set. For another example, the first CSI-RS resource belongs to a first CSI-RS resource set, the second CSI-RS resource belongs to a second CSI-RS resource set, and there is an intersection or no intersection between the first CSI-RS resource set and the second CSI-RS resource set.

In some examples, in the case that the downlink pilot signal is the DMRS, at least two DMRSs are configured for the terminal by the network device through high-layer signaling.

In summary, according to the AI-based CSI reporting method provided in this embodiment, it can measure channel quality more accurately, thereby performing downlink data transmission based on a more accurate channel quality measurement result.

FIG. 4 shows a flow chart of a CSI receiving method based on AI provided by an illustrative embodiment of the present disclosure. The method is applied to the communication system shown in FIG. 1 and is performed by a network device. The method includes the following.

Step 301, first CSI is received, where the first CSI is CSI corresponding to a downlink pilot signal that is reported by a terminal based on a codebook.

The network device sends downlink pilot signal, and receives the CSI corresponding to the downlink pilot signal sent by the terminal.

In some examples, the first CSI includes PMI; or the first CSI includes PMI and RI; or the first CSI includes PMI, RI and first CQI. For example, the RI and the first CQI are determined based on the second downlink channel information corresponding to the downlink pilot signal.

For example, the PMI is determined by the terminal based on second downlink channel information corresponding to the downlink pilot signal and fed back to the network device. Alternatively, the PMI is PMI corresponding to the maximum allowed number of transport streams of the terminal that is determined by the terminal based on the second downlink channel information. Alternatively, the PMI is PMI corresponding to the number of transport streams indicated by the RI that is determined by the terminal based on the second downlink channel information.

Alternatively, in the case where the network device configures codebook parameters for the terminal, the PMI is the PMI corresponding to the maximum allowed number of transport streams determined by the terminal based on the codebook parameters and the second downlink channel information. The RI can be used to indicate the number of transport streams reported by the terminal to the network device. The number of transport streams indicated by the RI is less than or equal to the maximum allowed number of transport streams of the terminal.

For example, in the case where the first CSI includes RI, the RI is the maximum allowed number of transport streams of the terminal. Alternatively, the RI is determined by the terminal based on the second downlink channel information and fed back to the network device. Alternatively, in the case where the network device configures codebook parameters for the terminal, the RI is determined by the terminal based on the codebook parameters and the second downlink channel information.

In some examples, the downlink pilot signal includes a CSI-RS.

In some examples, the codebook includes a Type I codebook or a Type II codebook. The codebook parameters include Type I codebook parameters or Type II codebook parameters. For example, the codebook parameters are configured for the terminal by the network device through RRC.

For example, the maximum allowed number of transport streams of the terminal may be predefined by a protocol; or the maximum allowed number of transport streams of the terminal may be determined based on the codebook parameter configured by the network device.

Step 302, P beams for the beam-formed downlink pilot signal are determined based on the first CSI through AI.

The network device determines a precoding matrix of the beam-formed downlink pilot signal based on the AI; and determines P beams of the beam-formed downlink pilot signal based on the precoding matrix; where P is a positive integer. For example, the precoding matrix includes P beams.

In some examples, an AI model is deployed in the network device; the network device inputs PMI into the AI model to obtain the precoding matrix of the beamformed downlink pilot signal; and then determines the P beams of the beamformed downlink pilot signal based on the precoding matrix.

For example, the AI model is obtained through online training; or the AI model is obtained through offline training. For example, in order to ensure the timeliness of the AI model, the network device periodically retrains and updates the AI model.

Step 303, the beamformed downlink pilot signal is sent to the terminal based on P beams.

The network device determines a downlink pilot signal port corresponding to each of the P beams, and sends the beamformed downlink pilot signal to the terminal through the downlink pilot signal port, where the downlink pilot signal port is an antenna port used for sending the beamformed downlink pilot signal.

In some examples, the beamformed downlink pilot signal includes a beamformed CSI-RS. For example, the network device determines a CSI-RS port corresponding to each of the P beams, and the network device sends the beamformed downlink pilot signal to the terminal through the CSI-RS port. The CSI-RS port is an antenna port used for sending the beamformed CSI-RS.

In some examples, the number of beams P is any one of the following:
the maximum allowed number of transport streams of the terminal;
   or
the number of transport streams indicated by the RI reported by the terminal.

Step 304, second CSI is received, where the second CSI is CSI corresponding to the beamformed downlink pilot signal that is reported by the terminal based on a codebook, and the second CSI is used by the network device for downlink data transmission.

In some examples, in the case that the first CSI includes only PMI, the second CSI includes CQI.

In some examples, in the case that the first CSI includes PMI and RI, the second CSI includes CQI.

In some examples, in the case that the first CSI includes only PMI, the second CSI includes RI and CQI.

In some examples, in the case that the first CSI includes PMI, RI and first CQI, the second CSI includes second CQI. The second CQI is used as an update parameter, that is, the second CQI is used to update the first RI reported by the terminal so that the downlink data transmission is performed based on the second CQI.

The second CSI is determined by the terminal based on first downlink channel information corresponding to the beamformed downlink pilot signal and fed back to the network device. For example, the CQI is determined by the terminal based on the first downlink channel information corresponding to the beamformed downlink pilot signal and fed back to the network device; or the RI and CQI are determined by the terminal based on the first downlink channel information corresponding to the beamformed downlink pilot signal and fed back to the network device.

For example, in the case that the second CSI includes RI, RI may be determined by the terminal based on the first downlink channel information and fed back to the network device; or, RI is determined by the terminal based on the second downlink channel information and fed back to the network device.

For example, in the case that neither the reported first CSI nor the reported second CSI includes RI, the network device may determine RI based on PMI.

In some examples, the codebook includes a Type I codebook or a Type II codebook. For example, the codebook used by the terminal in reporting the second CSI is the same as or different from the codebook used in reporting the first CSI. For example, the terminal uses the Type I codebook or the Type II codebook to report the first CSI and the second CSI. For another example, the terminal uses the Type I codebook to report the first CSI and uses the Type II codebook to report the second CSI; or, the terminal uses the Type II codebook to report the first CSI and uses the Type I codebook to report the second CSI.

In some examples, RI is used to indicate the number of transport streams, and the number of transport streams indicated by RI is less than or equal to the maximum allowed number of transport streams of the terminal.

In summary, according to the AI-based CSI receiving method provided in this embodiment, a codebook is used on the terminal side for CSI feedback, and AI is used on the network device side. The network device determines the beam required for transmission of the beamformed downlink pilot signal based on AI, that is, the AI network is deployed only on the network device side, and the terminal side does not need to deploy the AI network, and can still use the codebook for CSI feedback, so there is no need for too much standardization work. Compared with traditional CSI reporting, this technical solution can improve downlink data transmission performance under the same CSI feedback overhead because the network device side can restore the precoding with higher-precision based on AI.

In some other embodiments, before sending the downlink pilot signal and the beamformed downlink pilot signal to the terminal, the network device further configures downlink pilot signal resources for the terminal, and sends the downlink pilot signal and the beamformed downlink pilot signal based on the downlink pilot signal resources.

For example, as shown in FIG. 5, the CSI receiving method based on AI may further include step 305 before step 301, as shown below.

Step 305, a configured downlink pilot signal resource is sent to the terminal.

For example, the network device sends the downlink pilot signal through K ports of the downlink pilot signal resource; and then sends the beamformed downlink pilot signal through K ports of the downlink pilot signal resource, where K is a positive integer and is less than or equal to P.

In some examples, the network device sends at least two configured downlink pilot signal resources to the terminal.

For example, the at least two downlink pilot signal resources include a first downlink pilot signal resource corresponding to the beamformed downlink pilot signal and a second downlink pilot signal resource corresponding to the downlink pilot signal.

In some examples, the at least two downlink pilot signal resources have the same or different numbers of ports. For example, the number of ports of the first downlink pilot signal resource and the number of ports of the second downlink pilot signal resource are both K1, and K1 is a positive integer. For another example, the number of ports of the first downlink pilot signal resource is K1, the number of ports of the second downlink pilot signal resource is K2, and K1 and K2 are positive integers with different values.

For example, in the case where the at least two downlink pilot signal resources have the same number of ports, during the CSI feedback process, the network device sends the downlink pilot signal to the terminal through the K ports of the second downlink pilot signal resource, and then sends the beamformed downlink pilot signal to the terminal through the K ports of the first downlink pilot signal resource based on P beams.

In some examples, the number K of ports of the downlink pilot signal resource is configured by the network device for the terminal; or, the number K of ports of the downlink pilot signal resource is determined according to the maximum allowed number of transport streams of the terminal; or, the number K of ports of the downlink pilot signal resource is determined according to the number of transport streams indicated by the RI reported by the terminal.

For example, the number of ports of the first downlink pilot signal resource corresponding to the beamformed downlink pilot signal is any one of the following:
a value indicated by RI;
a value predefined by a protocol; or
a value that is configured for the terminal by the network device.

In some examples, the downlink pilot signal includes at least one of a CSI-RS or a DMRS; and the beamformed downlink pilot signal includes at least one of a beamformed CSI-RS or a beamformed DMRS. For example, the downlink pilot signal is the CSI-RS, and the beamformed downlink pilot signal is the beamformed CSI-RS; for another example, the downlink pilot signal is the DMRS, and the beamformed downlink pilot signal is the beamformed DMRS.

In some examples, in the case that the downlink pilot signal is a CSI-RS and the beamformed downlink pilot signal is a beamformed CSI-RS, at least two CSI-RS resources belong to the same or different CSI-RS resource sets. For example, the first CSI-RS resource and the second CSI-RS resource both belong to the same CSI-RS resource set; for another example, the first CSI-RS resource belongs to a first CSI-RS resource set, the second CSI-RS resource belongs to a second CSI-RS resource set, and there is an intersection or no intersection between the first CSI-RS resource set and the second CSI-RS resource set.

In some examples, in the case that the downlink pilot signal is a DMRS, at least two DMRSs are configured for the terminal by the network device through high-layer signaling.

In this embodiment, after receiving the second CSI, the network device further performs step 306 as shown below.

Step 306, downlink data transmission is performed based on RI, CQI and a precoding matrix.

For example, the network device determines the number of transport streams for downlink data transmission according to the RI, determines a modulation level for the downlink data transmission according to the CQI, and performs the downlink data transmission based on the number of transport streams, the modulation level, and the precoding matrix. The modulation level refers to a level of Modulation and Coding Scheme (MCS).

For example, in the case that the second CSI includes the second CQI, the network device determines the number of transport streams for the downlink data transmission according to the RI, determines the modulation level for the downlink data transmission according to the second CQI; and performs the downlink data transmission based on the number of transport streams, the modulation level and the precoding matrix.

It should be noted that, in the case that the RI of the terminal is predefined by a protocol, the RI is by default a known quantity in the network device and the terminal, and the terminal does not need to report the RI.

In summary, according to the AI-based CSI receiving method provided in this embodiment, it can measure the channel quality more accurately, thereby performing the downlink data transmission based on a more accurate channel quality measurement result.

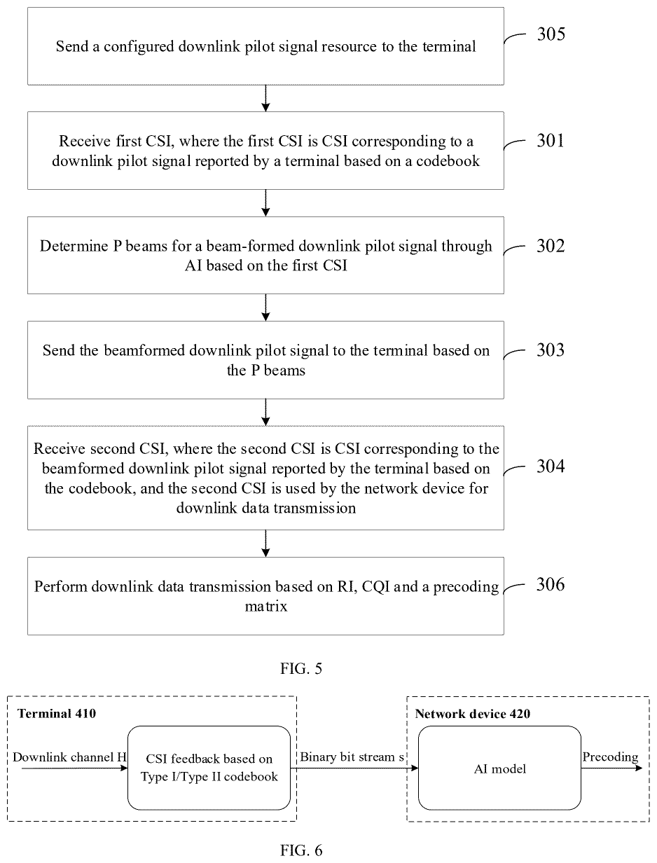

For example, the entire process of the CSI feedback described above is as shown in FIG. 6. After receiving the downlink channel information H, the terminal 410 performs the CSI feedback based on the Type1/Type2 codebook and feeds back a binary bit stream s to the network device 420; the network device 420 is deployed with an AI model, and determines a precoding matrix of the beamformed downlink pilot signal based on the AI model.

The CSI feedback may include the following four situations:
in a first situation, the first CSI includes PMI, and the second CSI includes CQI;
in a second situation, the first CSI includes PMI and RI, and the second CSI includes CQI;
in a third situation, the first CSI includes PMI, and the second CSI includes RI and CQI; and
in a fourth situation, the first CSI includes PMI, RI and first CQI, and the second CSI includes second CQI.

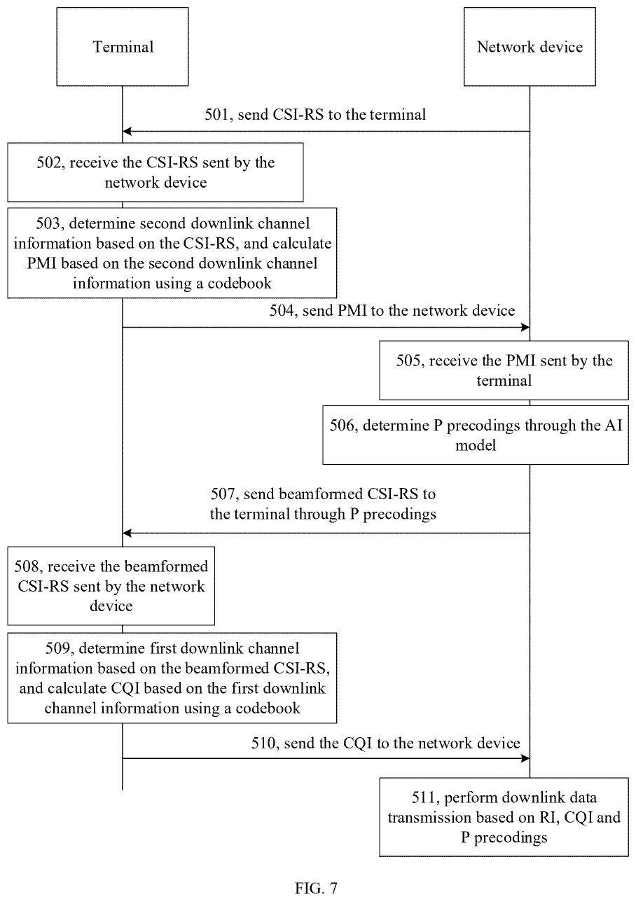

The four situations are described by taking the downlink pilot signal as CSI-RS and the beamformed downlink pilot signal as beamformed CSI-RS as an example. In the first situation, RI is known on both the network device side and the terminal side by default, and the communication between the terminal and the network device is as shown in FIG. 7, including the steps as follows.

Step 501, a network device sends a CSI-RS to a terminal.

Step 502, the terminal receives the CSI-RS sent by the network device.

Step 503, the terminal determines second downlink channel information based on the CSI-RS, and calculates PMI based on the second downlink channel information using a codebook.

The terminal calculates the PMI corresponding to the number of transport streams according to codebook parameters configured by the network device through the RRC and the second downlink channel information.

Step 504, the terminal sends PMI to the network device.

Step 505, the network device receives the PMI sent by the terminal.

Step 506, the network device determines P precodings through the AI model.

P is the number of transport streams indicated by RI, and P is a positive integer. The AI model has been deployed in the network device, and the network device uses PMI as input information of the AI model, and determines a precoding matrix corresponding to the beamformed CSI-RS through the AI model, and the precoding matrix includes P precodings (i.e., P beams).

Step 507, the network device sends the beamformed CSI-RS to the terminal through the P precodings.

Assuming that the rank indicated by the RI is rank=2, the network device determines the precoding matrix W=[B1 B2] through the AI model. When the network device sends the beamformed CSI-RS to the terminal, the beam used by port 1 of the CSI-RS resource is B1, and the beam used by port 2 of the CSI-RS resource is B2.

Step 508, the terminal receives the beamformed CSI-RS sent by the network device.

Step 509, the terminal determines first downlink channel information based on the beamformed CSI-RS, and calculates CQI based on the first downlink channel information using a codebook.

The terminal determines the first downlink channel information according to the beamformed CSI-RS, and calculates a bandwidth and/or sub-band CQI corresponding to rank=2.

Step 510, the terminal sends CQI to the network device.

The terminal quantifies the CQI and reports it to the network device.

Step 511, the network device performs downlink data transmission based on RI, CQI and the P precodings.

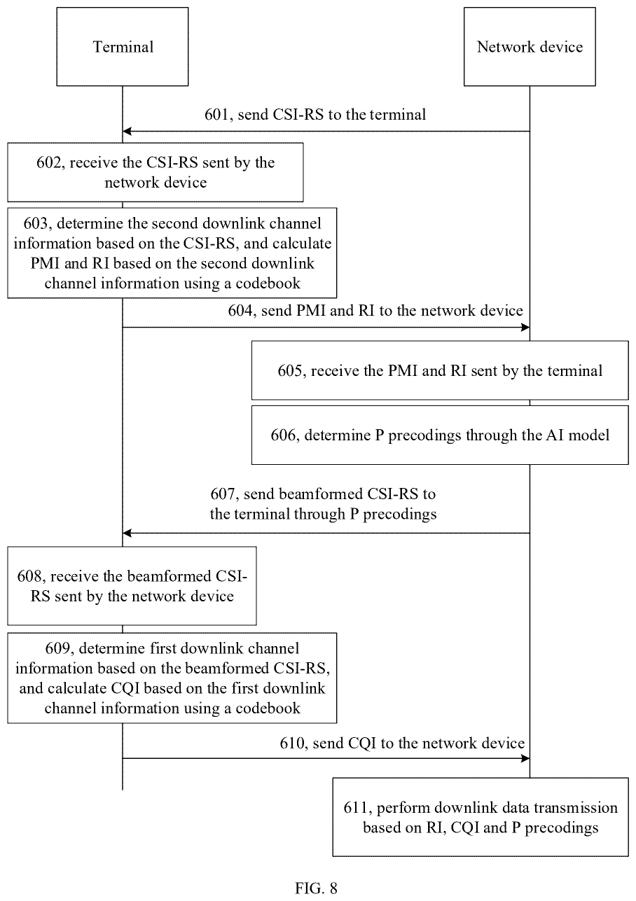

In the second situation, the communication between the terminal and the network device is as shown in FIG. 8, including the steps as follows.

Step 601, a network device sends a CSI-RS to a terminal.

Step 602, the terminal receives the CSI-RS sent by the network device.

Step 603, the terminal determines second downlink channel information based on the CSI-RS, and calculates PMI and RI based on the second downlink channel information using a codebook.

The terminal calculates the number of transport streams, i.e., the rank, and the PMI corresponding to the rank according to the codebook parameters configured by the network device through RRC and the second downlink channel information, where a value of the rank is indicated by RI.

Step 604, the terminal sends PMI and RI to the network device.

Step 605, the network device receives the PMI and RI sent by the terminal.

Step 606, the network device determines P precodings through the AI model.

P is the number of transport streams indicated by RI, and P is a positive integer. The AI model has been deployed in the network device, and the network device uses PMI as input information of the AI model, and determines the precoding matrix corresponding to the number of transport streams indicated by RI through the AI model, and the precoding matrix includes P precodings.

Step 607, the network device sends the beamformed CSI-RS to the terminal through the P precodings.

Assuming that the rank indicated by the RI reported by the terminal is rank=2, the network device determines the precoding matrix W=[B1 B2] through the AI model. When the network device sends the beamformed CSI-RS to the terminal, the beam used by port 1 of the CSI-RS resource is B1, and the beam used by port 2 of the CSI-RS resource is B2.

Step 608, the terminal receives the beamformed CSI-RS sent by the network device.

Step 609, the terminal determines first downlink channel information based on the beamformed CSI-RS, and calculates CQI based on the first downlink channel information using a codebook.

The terminal determines the first downlink channel information according to the beamformed CSI-RS, and calculates the bandwidth and/or sub-band CQI corresponding to rank=2.

Step 610, the terminal sends CQI to the network device.

The terminal quantifies the CQI and reports it to the network device.

Step 611, the network device performs downlink data transmission based on RI, CQI and P precodings.

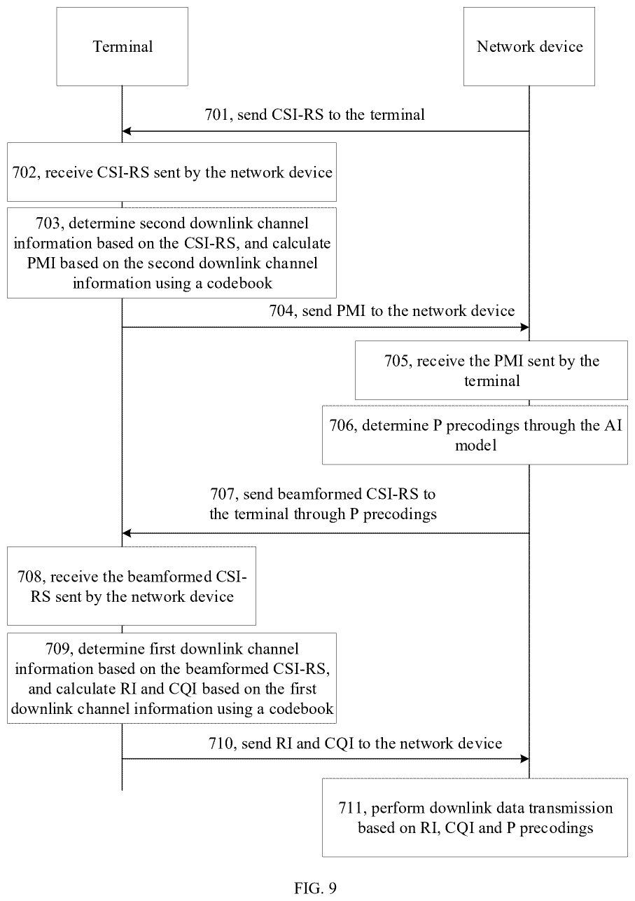

In the third situation, the communication between the terminal and the network device is as shown in FIG. 9, including the steps as follows.

Step 701, the network device sends a CSI-RS to the terminal.

Step 702, the terminal receives the CSI-RS sent by the network device.

Step 703, the terminal determines second downlink channel information based on the CSI-RS, and calculates PMI based on the second downlink channel information using a codebook.

It is assumed that the maximum allowed number of transport streams of the terminal is 4, that is, rank=4. The terminal calculates the PMI corresponding to rank-4 according to the codebook parameters configured by the network device through RRC and the second downlink channel information, and the value of the rank is indicated by RI.

Step 704, the terminal sends PMI to the network device.

Step 705, the network device receives the PMI sent by the terminal.

Step 706, the network device determines P precodings through the AI model.

P is the number of transport streams indicated by RI, and P is a positive integer. The AI model is deployed in the network device; the network device uses PMI as input information of the AI model, and determines the precoding matrix W=[B1 B2 B3 B4] corresponding to rank=4 through the AI model.

Step 707, the network device sends the beamformed CSI-RS to the terminal through P precodings.

The number of ports of the CSI-RS resource used by the network device is 4, and the 4 CSI-RS resource ports correspond to the used beams B1, B2, B3 and B4 respectively.

Step 708, the terminal receives the beamformed CSI-RS sent by the network device.

Step 709, the terminal determines first downlink channel information based on the beamformed CSI-RS, and calculates RI and CQI based on the first downlink channel information using a codebook.

The terminal calculates rank-2 corresponding to the current channel and the bandwidth and/or sub-bandwidth CQI corresponding to rank=2 based on the beamformed CSI-RS, and the rank corresponding to the current channel is indicated by RI.

Step 710, the terminal sends RI and CQI to the network device.

Step 711, the network device performs downlink data transmission based on RI, CQI and P precodings.

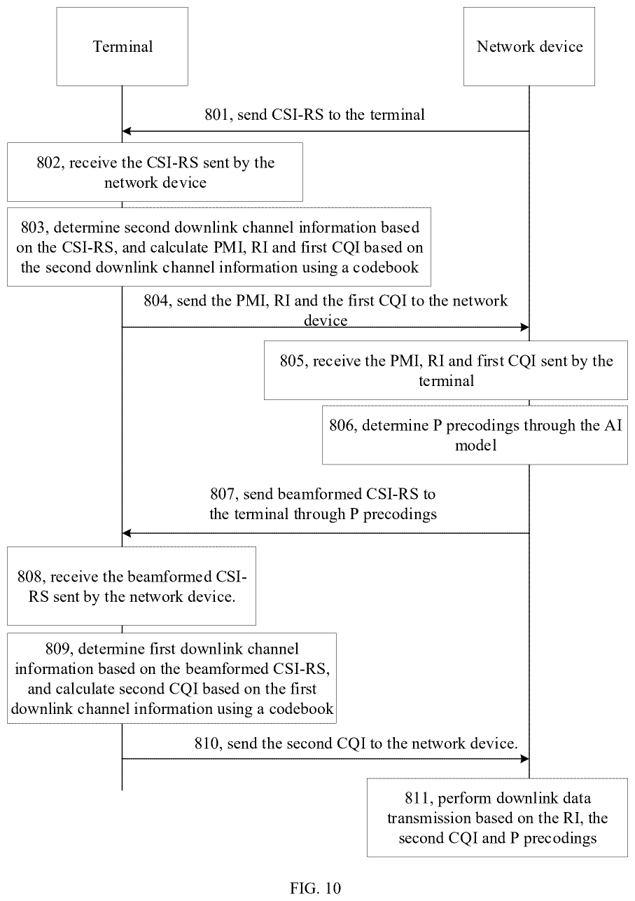

In the fourth situation, the communication between the terminal and the network device is as shown in FIG. 10, including the steps as follows.

Step 801, the network device sends a CSI-RS to the terminal.

Step 802, the terminal receives the CSI-RS sent by the network device.

Step 803, the terminal determines second downlink channel information based on the CSI-RS, and calculates PMI, RI and first CQI based on the second downlink channel information using a codebook.

For example, the terminal calculates the RI, the PMI corresponding to the RI, and the first CQI according to the codebook parameters configured by the network device through the RRC and the second downlink channel information.

Step 804, the terminal sends the PMI, RI and first CQI to the network device.

Step 805, the network device receives the PMI, RI and first CQI sent by the terminal.

Step 806, the network device determines P precodings through the AI model.

P is the number of transport streams indicated by RI, i.e., the rank, and P is a positive integer. The AI model is deployed in the network device; in the case of rank=4, the network device uses PMI as input information of the AI model, and determines the precoding matrix W=[B1 B2 B3 B4] corresponding to rank=4 through the AI model.

For example, the network device uses the PMI and the first CQI as input information of the AI model, and determines the precoding matrix corresponding to the beamformed downlink pilot signal through the AI model, where the precoding matrix includes P precodings.

Step 807, the network device sends the beamformed CSI-RS to the terminal through the P precodings.

The number of ports of the CSI-RS resources used by the network device is 4, and the 4 CSI-RS resource ports correspond to beams B1, B2, B3, and B4, respectively.

Step 808, the terminal receives the beamformed CSI-RS sent by the network device.

Step 809, the terminal determines first downlink channel information based on the beamformed CSI-RS, and calculates second CQI based on the first downlink channel information using a codebook.

The terminal determines the first downlink channel information according to the beamformed CSI-RS, calculates the bandwidth and/or sub-band CQI corresponding to rank=4 to obtain the second CQI.

Step 810, the terminal sends the second CQI to the network device.

Step 811, the network device performs downlink data transmission based on the RI, the second CQI and the P precodings.

In summary, according to the AI-based CSI reporting method provided in this embodiment, a codebook is used on the terminal side for CSI feedback, and AI is used on the network device side. The network device determines the beams required for transmission of the beamformed downlink pilot signal n based on AI, that is, the AI network is deployed only on the network device side, and the terminal side does not need to deploy the AI network, and can still use the codebook for CSI feedback, so there is no need for too much standardization work. Compared with traditional CSI reporting, this technical solution can improve downlink data transmission performance under the same CSI feedback overhead because the network device side can restore the precoding with higher precision based on AI.

The AI-based CSI reporting method provided in this embodiment also supports reporting of RI, CQI, and PMI step-by-step, so that in the CSI feedback process, a high-precision precoding matrix can be determined based on PMI, and then CSI feedback can be performed on the beamformed downlink pilot signal sent through the precoding matrix to obtain a more accurate CQI, achieving downlink data transmission with high performance.

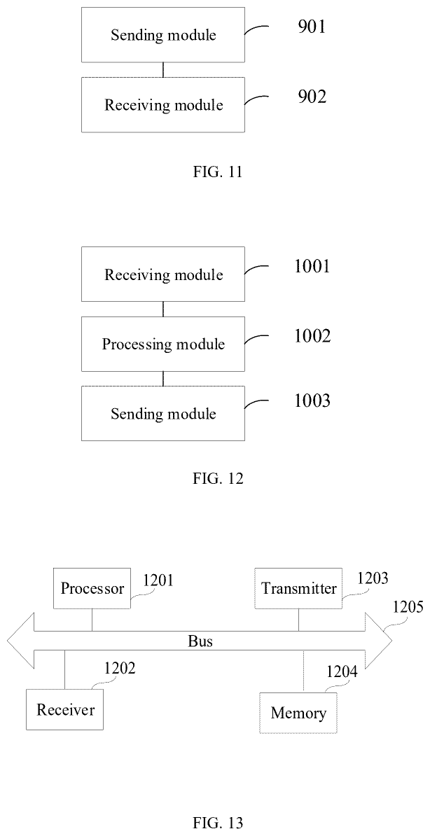

FIG. 11 shows a block diagram of an AI-based CSI reporting device provided by an illustrative embodiment of the present disclosure. The device can be implemented as a part or an entirety of a terminal through software, hardware, or a combination of the both. The device includes:
a sending module 901, configured to report first CSI corresponding to a downlink pilot signal to a network device based on a codebook; and
a receiving module 902, configured to receive a beamformed downlink pilot signal sent by the network device, where the beam of the beamformed downlink pilot signal is determined by the network device through AI based on the first CSI;
where the sending module 901 is configured to report second CSI corresponding to the beamformed downlink pilot signal to the network device based on the codebook, where the second CSI is used for the network device to perform downlink data transmission.

In some embodiments, the first CSI includes PMI; and the second CSI includes CQI.

The sending module 901 is configured to report the PMI corresponding to the downlink pilot signal to the network device based on the codebook.

The sending module 901 is configured to report the CQI corresponding to the beamformed downlink pilot signal to the network device based on the codebook.

In some embodiments, the sending module 901 is configured to determine first downlink channel information based on the beamformed downlink pilot signal; determine the CQI based on the first downlink channel information; and report the CQI to the network device based on the codebook.

In some embodiments, the sending module 901 is configured to determine second downlink channel information based on the downlink pilot signal; determine the PMI based on the second downlink channel information; and report the PMI to the network device based on the codebook.

In some embodiments, the first CSI includes PMI and RI, and the second CSI includes CQI.

The sending module 901 is configured to report the PMI and the RI corresponding to the downlink pilot signal to the network device based on the codebook.

The sending module 901 is configured to report the CQI corresponding to the beamformed downlink pilot signal to the network device based on the codebook.

In some embodiments, the sending module 901 is configured to determine first downlink channel information based on the beamformed downlink pilot signal; determine the CQI based on the first downlink channel information; and report the CQI to the network device based on the codebook.

In some embodiments, the sending module 901 is configured to determine second downlink channel information based on the downlink pilot signal; determine the RI and the PMI corresponding to the RI based on the second downlink channel information; and report the PMI and the RI to the network device based on the codebook.

In some embodiments, the first CSI includes PMI; and the second CSI includes RI and CQI.

The sending module 901 is configured to report the PMI corresponding to the downlink pilot signal to the network device based on the codebook.

The sending module 901 is configured to report the RI and the CQI corresponding to the beamformed downlink pilot signal to the network device based on the codebook.

In some embodiments, the sending module 901 is configured to determine first downlink channel information based on the beamformed downlink pilot signal; determine the RI and the CQI based on the first downlink channel information; and report the RI and the CQI to the network device based on the codebook.

In some embodiments, the sending module 901 is configured to determine second downlink channel information based on the downlink pilot signal; determine the PMI based on the second downlink channel information; and report the PMI to the network device based on the codebook.

In some embodiments, the first CSI includes PMI, RI and first CQI; and the second CSI includes second CQI.

The sending module 901 is configured to report the PMI, the RI and the first CQI corresponding to the downlink pilot signal to the network device based on the codebook.

The sending module 901 is configured to report the second CQI corresponding to the beamformed downlink pilot signal to the network device based on the codebook.

In some embodiments, the sending module 901 is configured to determine first downlink channel information based on the beamformed downlink pilot signal; determine the second CQI based on the first downlink channel information; and report the second CQI to the network device based on the codebook.

In some embodiments, the sending module 901 is configured to determine the second downlink channel information based on the downlink pilot signal; determine the PMI, the RI and the first CQI based on the second downlink channel information; and report the PMI, the RI and the first CQI to the network device based on the codebook.

In some embodiments, the receiving module 902 is configured to receive at least two downlink pilot signal resources configured by the network device.

In some embodiments, the at least two downlink pilot signal resources have the same or different numbers of ports.

In some embodiments, in the case that the downlink pilot signal is a CSI-RS and the beamformed downlink pilot signal is a beamformed CSI-RS, at least two CSI-RS resources belong to the same or different CSI-RS resource sets.

In some embodiments, the at least two downlink pilot signal resources include a first downlink pilot signal resource corresponding to the beamformed downlink pilot signal; the number of ports of the first downlink pilot signal resource is any one of the following:
a value indicated by RI;
a value predefined by a protocol; or
a value configured by the network device for the terminal.

In some embodiments, the downlink pilot signal includes at least one of a CSI-RS or a DMRS, and the beamformed downlink pilot signal includes at least one of a beamformed CSI-RS or a beamformed DMRS.

In some embodiments, the codebook comprises a Type I codebook or a Type II codebook.

FIG. 12 shows a block diagram of an AI-based CSI receiving device provided by an illustrative embodiment of the present disclosure. The device can be implemented as a part or an entirety of a network device through software, hardware, or a combination of the both. The device includes:
a receiving module 1001, configured to receive first CSI, where the first CSI is CSI corresponding to a downlink pilot signal that is reported by a terminal based on a codebook;
a processing module 1002, configured to determine P beams for a beam-formed downlink pilot signal based on the first CSI through AI, where P is a positive integer; and
a sending module 1003, configured to send the beamformed downlink pilot signal to the terminal based on the P beams;
where the receiving module 1001 is configured to receive second CSI, the second CSI is CSI corresponding to the beamformed downlink pilot signal that is reported by the terminal based on the codebook, and the second CSI is used for the network device to perform downlink data transmission.

In some embodiments, the processing module 1002 is configured to determine a precoding matrix of the beamformed downlink pilot signal based on the AI; and determine the P beams of the beamformed downlink pilot signal based on the precoding matrix.

In some embodiments, the first CSI includes PMI.

The processing module 1002 is configured to input the PMI into the AI model to obtain the precoding matrix of the beamformed downlink pilot signal.

In some embodiments, the second CSI includes CQI; or
the first CSI further includes RI, and the second CSI includes the CQI; or
the second CSI includes the RI and the CQI.

In some embodiments, the CQI is determined by the terminal based on first downlink channel information corresponding to the beamformed downlink pilot signal and fed back to the network device; and
the PMI is determined by the terminal based on second downlink channel information corresponding to the downlink pilot signal and fed back to the network device.

In some embodiments, the RI is determined by the terminal based on the first downlink channel information and fed back to the network device; or the RI is determined by the terminal based on the second downlink channel information and fed back to the network device.

In some embodiments, the first CSI also includes RI and first CQI, and the second CSI includes second CQI; where the RI and the first CQI are determined based on the second downlink channel information corresponding to the downlink pilot signal, and the second CQI is determined based on the first downlink channel information corresponding to the beamformed downlink pilot signal.

In some embodiments, the sending module 1003 is configured to send the beamformed downlink pilot signal to the terminal through K ports of downlink pilot signal resources based on the P beams, where K is a positive integer and P is less than or equal to K.

In some embodiments, the sending module 1003 is configured to send at least two configured downlink pilot signal resources to the terminal.

In some embodiments, the at least two downlink pilot signal resources have the same or different numbers of ports.

In some embodiments, in the case that the downlink pilot signal is a CSI-RS and the beamformed downlink pilot signal is a beamformed CSI-RS, at least two CSI-RS resources belong to the same or different CSI-RS resource sets.

In some embodiments, the at least two downlink pilot signal resources include a first downlink pilot signal resource corresponding to the beamformed downlink pilot signal, and the number of ports of the first downlink pilot signal resource is any one of the following:
a value indicated by RI;
a value predefined by a protocol; or
a value configured by the network device for the terminal.

In some embodiments, the downlink pilot signal includes at least one of a CSI-RS or a DMRS, and the beamformed downlink pilot signal includes at least one of a beamformed CSI-RS or a beamformed DMRS.

In some embodiments, the number P of beams is any one of the following:
the maximum allowed number of transport streams of the terminal;
   or
the number of transport streams indicated by the RI reported by the terminal.

In some embodiments, the number K of ports of the downlink pilot signal resource is configured by the network device for the terminal; or, the number K of ports of the downlink pilot signal resource is determined according to the maximum allowed number of transport streams of the terminal; or, the number K of ports of the downlink pilot signal resource is determined according to the number of transport streams indicated by the RI reported by the terminal.

In some embodiments, the codebook comprises a Type I codebook or a Type II codebook.

In some embodiments, the sending module 1003 is configured to perform downlink data transmission based on the RI, the CQI and the precoding matrix.

FIG. 13 shows a schematic structural diagram of a UE provided by an illustrative embodiment of the present disclosure. The UE includes: a processor 1201, a receiver 1202, a transmitter 1203, a memory 1204 and a bus 1205.

The processor 1201 includes one or more processing cores. The processor 1201 executes various functional applications and information processing by running software programs and modules.

The receiver 1202 and the transmitter 1203 may be implemented as one communication component, which may be a communication chip.

The memory 1204 is connected to the processor 1201 via the bus 1205.

The memory 1204 may be configured to store at least one instruction, and the processor 1201 may be configured to execute the at least one instruction to implement the steps in the above method embodiments.

In addition, the memory 1204 can be implemented by any type of volatile or non-volatile storage device or a combination thereof. The volatile or non-volatile storage device includes but is not limited to: a magnetic disk or an optical disk, an Electrically Erasable Programmable Read Only Memory (EEPROM), an Erasable Programmable Read-Only Memory (EPROM), a Static Random-Access Memory (SRAM), a Read Only Memory (ROM), a magnetic memory, a flash memory, and a Programmable Read Only Memory (PROM).

In an illustrative embodiment, there is also provided a non-transitory computer-readable storage medium including instructions, such as a memory including instructions, and the instructions can be executed by a processor of a UE to complete the above AI-based CSI reporting method. For example, the non-transitory computer-readable storage medium can be a ROM, a Random Access Memory (RAM), a Compact Disc-Read Only Memory (CD-ROM), a magnetic tape, a floppy disk, an optical data storage device, and the like.

A non-transitory computer-readable storage medium. When the instructions in the non-transitory computer storage medium are executed by a processor of a UE, the UE is enabled to perform the AI-based CSI reporting method as described above.

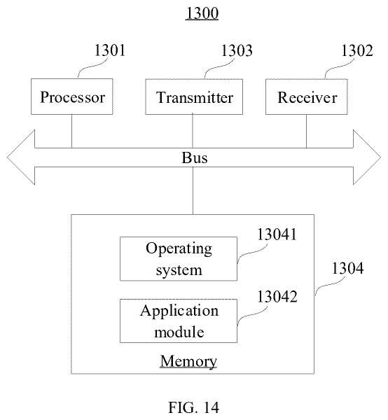

FIG. 14 is a block diagram showing a network device 1300 according to an illustrative embodiment. The network device 1300 may be a base station.

The network device 1300 may include: a processor 1301, a receiver 1302, a transmitter 1303 and a memory 1304. The receiver 1302, the transmitter 1303 and the memory 1304 are respectively connected to the processor 1301 via a bus.

The processor 1301 includes one or more processing cores, and the processor 1301 performs the AI-based CSI receiving method provided by the embodiments of the present disclosure by running software programs and modules. The memory 1304 can be configured to store software programs and modules. Specifically, the memory 1304 can store an operating system 13041 and an application module 13042 required for at least one function. The receiver 1302 is configured to receive communication data sent by other devices, and the transmitter 1303 is configured to send communication data to other devices.

An illustrative embodiment of the present disclosure also provides a computer-readable storage medium having stored thereon at least one instruction, at least one program, a code set or an instruction set which is loaded and executed by the processor to implement the AI-based CSI reporting method or the AI-based CSI receiving method provided in the various method embodiments as described above.

An illustrative embodiment of the present disclosure also provides a computer program product which includes computer instructions, and the computer instructions are stored in a computer-readable storage medium; a processor of a computer device reads the computer instructions from the computer-readable storage medium, and the processor executes the computer instructions to cause the computer device to perform the AI-based CSI reporting method or the AI-based CSI receiving method as provided in the above various method embodiments.

It should be understood that “a plurality of” mentioned herein refers to two or more. “And/or” describes the association relationship of the associated objects, indicating that there can be three relationships. For example, A and/or B can indicate: A exists alone, A and B exist at the same time, and B exists alone. The character “/” generally indicates that the associated objects before and after this character are in an “or” relationship.

It can be further understood that the terms “first”, “second”, etc. are used to describe various information, but such information should not be limited to these terms. These terms are only used to distinguish the same type of information from each other, and do not indicate a specific order or degree of importance. In fact, the expressions “first”, “second”, etc. can be used interchangeably. For example, without departing from the scope of the present disclosure, the first message frame can also be referred to as the second message frame, and similarly, the second message frame can also be referred to as the first message frame.

It can be further understood that although operations are described in a specific order in the drawings in the embodiments of the present disclosure, it should not be interpreted as requiring that these operations be performed in the specific order shown or in a serial order, or requiring that all the operations shown be performed.

Those skilled in the art will readily appreciate other embodiments of the present disclosure after considering the specification and practicing the disclosure disclosed herein. The present disclosure is intended to cover any variations, uses, or adaptations of the present disclosure that follow the general principles of the present disclosure and include common knowledge or conventional technical measures in the art that are not disclosed in the present disclosure. The description and examples are to be considered illustrative only, and the true scope and spirit of the present disclosure are indicated by the following claims.

It should be understood that the present disclosure is not limited to the precise structures that have been described above and shown in the drawings, and that various modifications and changes may be made without departing from the scope thereof. The scope of the present disclosure is limited only by the appended claims.

1. An artificial intelligence (AI)-based CSI reporting method, performed by a terminal, the method comprising:
reporting first channel state information (CSI) corresponding to a downlink pilot signal to a network device based on a codebook;
receiving a beamformed downlink pilot signal sent by the network device, wherein a beam of the beamformed downlink pilot signal is determined by the network device through AI based on the first CSI; and
reporting second CSI corresponding to the beamformed downlink pilot signal to the network device based on the codebook, wherein the second CSI is used for the network device to perform downlink data transmission.

2. The method according to claim 1, wherein the first CSI comprises precoding matrix indication (PMI), and the second CSI comprises channel quality indication (CQI),
the reporting the first CSI corresponding to the downlink pilot signal to the network device based on the codebook comprises:
reporting the PMI corresponding to the downlink pilot signal to the network device based on the codebook, and
the reporting the second CSI corresponding to the beamformed downlink pilot signal to the network device based on the codebook, comprises:
reporting the CQI corresponding to the beamformed downlink pilot signal to the network device based on the codebook.

3. The method according to claim 2, wherein the reporting the CQI corresponding to the beamformed downlink pilot signal to the network device based on the codebook comprises:
determining first downlink channel information based on the beamformed downlink pilot signal;
determining the CQI based on the first downlink channel information; and
reporting the CQI to the network device based on the codebook,
or
wherein the reporting the PMI corresponding to the downlink pilot signal to the network device based on the codebook comprises:
determining second downlink channel information based on the downlink pilot signal;
determining the PMI based on the second downlink channel information; and
reporting the PMI to the network device based on the codebook.

4. (canceled)

5. The method according to claim 1, wherein the first CSI comprises PMI and rank indication (RI), and the second CSI comprises CQI,
the reporting the first CSI corresponding to the downlink pilot signal to the network device based on the codebook comprises:
reporting the PMI and the RI corresponding to the downlink pilot signal to the network device based on the codebook, and
the reporting the second CSI corresponding to the beamformed downlink pilot signal to the network device based on the codebook comprises:
reporting the CQI corresponding to the beamformed downlink pilot signal to the network device based on the codebook.

6. The method according to claim 5, wherein the reporting the CQI corresponding to the beamformed downlink pilot signal to the network device based on the codebook comprises:
determining first downlink channel information based on the beamformed downlink pilot signal;
determining the CQI based on the first downlink channel information; and
reporting the CQI to the network device based on the codebook,
or
wherein the reporting the PMI and the RI corresponding to the downlink pilot signal to the network device based on the codebook comprises:
determining second downlink channel information based on the downlink pilot signal;
determining the RI and the PMI corresponding to the RI based on the second downlink channel information; and
reporting the PMI and the RI to the network device based on the codebook.

7. (canceled)

8. The method according to claim 1, wherein the first CSI comprises PMI, and the second CSI comprises RI and CQI,
the reporting the first CSI corresponding to the downlink pilot signal to the network device based on the codebook comprises:
reporting the PMI corresponding to the downlink pilot signal to the network device based on the codebook,
the reporting the second CSI corresponding to the beamformed downlink pilot signal to the network device based on the codebook comprises:
reporting the RI and the CQI corresponding to the beamformed downlink pilot signal to the network device based on the codebook.

9. The method according to claim 8, wherein the reporting the RI and the CQI corresponding to the beamformed downlink pilot signal to the network device based on the codebook comprises:
determining first downlink channel information based on the beamformed downlink pilot signal;
determining the RI and the CQI based on the first downlink channel information; and
reporting the RI and the CQI to the network device based on the codebook-,
or
wherein the reporting the PMI corresponding to the downlink pilot signal to the network device based on the codebook comprises:
determining second downlink channel information based on the downlink pilot signal;
determining the PMI based on the second downlink channel information; and
reporting the PMI to the network device based on the codebook.

10. (canceled)

11. The method according to claim 1, wherein the first CSI comprises PMI, RI and first CQI, and the second CSI comprises second CQI,
the reporting the first CSI corresponding to the downlink pilot signal to the network device based on the codebook comprises:
reporting the PMI, the RI and the first CQI corresponding to the downlink pilot signal to the network device based on the codebook;
the reporting the second CSI corresponding to the beamformed downlink pilot signal to the network device based on the codebook comprises:
reporting the second CQI corresponding to the beamformed downlink pilot signal to the network device based on the codebook.

12. The method according to claim 11, wherein the reporting the second CQI corresponding to the beamformed downlink pilot signal to the network device based on the codebook comprises:
determining first downlink channel information based on the beamformed downlink pilot signal;
determining the second CQI based on the first downlink channel information; and
reporting the second CQI to the network device based on the codebook,
or
wherein the reporting the PMI, the RI and the first CQI corresponding to the downlink pilot signal to the network device based on the codebook comprises:
determining second downlink channel information based on the downlink pilot signal;
determining the PMI, the RI and the first CQI based on the second downlink channel information; and
reporting the PMI, the RI and the first CQI to the network device based on the codebook.

13. (canceled)

14. The method according to claim 1, wherein the method further comprises:
receiving at least two downlink pilot signal resources configured by the network device.

15. The method according to claim 14, wherein the at least two downlink pilot signal resources comprise a first downlink pilot signal resource corresponding to the beamformed downlink pilot signal, and the number of ports of the first downlink pilot signal resource is any one of the following:
a value indicated by RI;
a value predefined by a protocol; or
a value configured by the network device for the terminal-,
or
wherein the downlink pilot signal comprises at least one of a channel state information reference signal (CSI-RS) or a demodulation reference signal (DMRS), and the beamformed downlink pilot signal comprises at least one of a beamformed CSI-RS or a beamformed DMRS.

16. (canceled)

17. An AI-based CSI receiving method, performed by a network device, the method comprising:
receiving first CSI, wherein the first CSI is CSI corresponding to a downlink pilot signal that is reported by a terminal based on a codebook;
determining P beams of a beamformed downlink pilot signal based on the first CSI through AI, wherein P is a positive integer;
sending the beamformed downlink pilot signal to the terminal based on the P beams; and
receiving second CSI, wherein the second CSI is CSI corresponding to the beamformed downlink pilot signal that is reported by the terminal based on the codebook, and the second CSI is used for the network device to perform downlink data transmission.

18. The method according to claim 17, wherein the determining the P beams of the beamformed downlink pilot signal based on the first CSI through the AI comprises:
determining a precoding matrix of the beamformed downlink pilot signal based on the AI; and
determining the P beams of the beamformed downlink pilot signal based on the precoding matrix,
wherein the first CSI comprises PMI,
the determining the precoding matrix of the beamformed downlink pilot signal based on the AI comprises:
obtaining the precoding matrix of the beamforming downlink pilot signal by inputting the PMI into an AI model.

19. (canceled)

20. The method according to claim 18, wherein
the second CSI comprises CQI; or
the first CSI further comprises RI, and the second CSI comprises the CQI; or
the second CSI comprises the RI and the CQI,
wherein the CQI is determined by the terminal based on first downlink channel information corresponding to the beamformed downlink pilot signal and fed back to the network device; and
the PMI is determined by the terminal based on second downlink channel information corresponding to the downlink pilot signal and fed back to the network device,
wherein the RI is determined by the terminal based on the first downlink channel information and fed back to the network device; or
the RI is determined by the terminal based on the second downlink channel information and fed back to the network device.

21.-22. (canceled)

23. The method according to claim 1918, wherein
the first CSI further comprises RI and first CQI, and the second CSI comprises second CQI, and
wherein the RI and the first CQI are determined based on second downlink channel information corresponding to the downlink pilot signal, and the second CQI is determined based on first downlink channel information corresponding to the beamformed downlink pilot signal.

24. The method according to claim 17, wherein the sending the beamformed downlink pilot signal to the terminal based on the P beams comprises:
sending the beamformed downlink pilot signal to the terminal through K ports of downlink pilot signal resources based on the P beams, wherein K is a positive integer and P is less than or equal to K,
wherein the method further comprises:
sending at least two configured downlink pilot signal resources to the terminal.

25. (canceled)

26. The method according to claim 2524, wherein the at least two downlink pilot signal resources include a first downlink pilot signal resource corresponding to the beamformed downlink pilot signal, and the number of ports of the first downlink pilot signal resource is any one of the following:
a value indicated by RI;
a value predefined by a protocol; or
a value configured by the network device for the terminal-,
or
wherein the downlink pilot signal comprises at least one of a CSI-RS or a DMRS, and the beamformed downlink pilot signal comprises at least one of a beamformed CSI-RS or a beamformed DMRS.

27. (canceled)

28. The method according to claim 20, wherein the method further comprises:
performing downlink date transmission based on the RI, the CQI and the precoding matrix.

29-30. (canceled)

31. A terminal, comprising:
a processor; and
a transceiver connected to the processor;
wherein the transceiver is configured to execute executable instructions to cause the terminal to:
report first channel state information (CSI) corresponding to a downlink pilot signal to a network device based on a codebook;
receive a beamformed downlink pilot signal sent by the network device, wherein a beam of the beamformed downlink pilot signal is determined by the network device through AI based on the first CSI; and
report second CSI corresponding to the beamformed downlink pilot signal to the network device based on the codebook, wherein the second CSI is used for the network device to perform downlink data transmission.

32. A network device, comprising:
a processor; and
a transceiver connected to the processor;
wherein the transceiver is configured to execute executable instructions to implement the AI-based CSI receiving method according to claim 17.

33. (canceled)
